(19) United States
(12) Patent Application Publication
(10) Pub. No.: US 2024/0288593 A1
(43) Pub. Date: Aug. 29, 2024

(54) Radiation Measuring System

(71) Applicant: Santiago Beron, Clearwater, FL (US)

(72) Inventor: Santiago Beron, Clearwater, FL (US)

(21) Appl. No.: 18/175,944

(22) Filed: Feb. 28, 2023

(51) Int. Cl. G01T 1/20

(52) U.S. Cl. CPC G01T 1/2002; G01T 1/2006; G01T 1/201

(57) ABSTRACT

A system is provided for measuring radiation, the system includes an optical fiber cable assembly coupled to one or more scintillation detectors, a data acquisition module for measuring an output generated by said one or more scintillation detectors and a cartridge module that is permanently engaged with said optical fiber cable assembly and removably engaged with said data acquisition module.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### BACKGROUND OF THE RELEVANT PRIOR ART

One or more embodiments of the invention generally relate to radiation measurement using scintillation detectors more particularly, certain embodiments of the invention relate to a removable cartridge system for connecting radiation sensors or scintillation detectors to a measuring system.

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Scintillation detectors are generally used for the measuring radiation such as high-energy part of the X-ray spectrum to enable imaging a field of view of a human body. Scintillator detectors convert the radiation i.e., the X-ray energy into visible light, wherein the light signal is passed through a fiber optic cable to a measuring system, for example an electrometer, to enable measurement.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that the current scintillation detectors use standard fiber optic connectors to tie the fiber optic cable to the measuring system. The standard fiber optic connectors are susceptable to measurement error arising from various conditions like presence of foreign particles such as dust, alignment error, etc.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is an illustration of an exemplary radiation measuring system comprising a removable cartridge module, in accordance with an embodiment of the present invention;

FIG. 2A is a side perspective view of the removable cartridge module, in accordance with an embodiment of the present invention;

FIG. 2B is an isometric view of the removable cartridge module, in accordance with an embodiment of the present invention;

FIG. 2C is a top perspective view of the removable cartridge module, in accordance with an embodiment of the present invention;

FIG. 2C.1 is an illustration of a fan-out kit, in accordance with and embodiment of the present invention;

FIG. 2D is a front view of the removable cartridge module, in accordance with an embodiment of the present invention;

FIG. 2E is a rear view of the removable cartridge module, in accordance with an embodiment of the present invention;

FIG. 3 is an illustration of a removable connector assembly of the removable cartridge module, in accordance with an embodiment of the present invention;

FIG. 3A is an illustration of a top board of the removable connector assembly, in accordance with an embodiment of the present invention;

FIG. 3B is an illustration of a top mount of the removable connector assembly, in accordance with an embodiment of the present invention;

FIG. 3C is an illustration of a back view and a side view of a ferrule holder of the removable connector assembly, in accordance with an embodiment of the present invention;

FIG. 3D is an illustration of a bottom board of the removable connector assembly, in accordance with an embodiment of the present invention;

FIG. 3E is an illustration of a spacer of the removable connector assembly, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, it is well settled law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [“substantially”] as connoting a term of approximation or a term of magnitude”). Here, when referring to the “substantially halfway” limitation, the Specification uses the word “approximately” as a substitute for the word “substantially” (Fact 4). (Fact 4). The ordinary meaning of “substantially halfway” is thus reasonably close to or nearly at the midpoint between the forwardmost point of the upper or outsole and the rearwardmost point of the upper or outsole.

Similarly, the term ‘substantially’ is well recognized in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003)” Id. at 1311. Similarly, the plain language of claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit—“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. § 112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to ‘avoid a strict numerical boundary to the specified parameter, see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”; e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104 F.2d 829, 42 USPQ 90, 93 (C.C.P.A. 1939) the court said, “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will be described in detail below with reference to embodiments thereof as illustrated in the accompanying drawings.

References to a “device,” an “apparatus,” a “system,” etc., in the preamble of a claim should be construed broadly to mean “any structure meeting the claim terms” exempt for any specific structure(s)/type(s) that has/(have) been explicitly disavowed or excluded or admitted/implied as prior art in the present specification or incapable of enabling an object/aspect/goal of the invention. Furthermore, where the present specification discloses an object, aspect, function, goal, result, or advantage of the invention that a specific prior art structure and/or method step is similarly capable of performing yet in a very different way, the present invention disclosure is intended to and shall also implicitly include and cover additional corresponding alternative embodiments that are otherwise identical to that explicitly disclosed except that they exclude such prior art structure(s)/step(s), and shall accordingly be deemed as providing sufficient disclosure to support a corresponding negative limitation in a claim claiming such alternative embodiment(s), which exclude such very different prior art structure(s)/step(s) way(s).

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” include the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred, or induced by any pattern(s) of description, embodiments, examples, or referenced prior-art that may (or may not) be provided in the present patent.

References to “end user”, or any similar term, as used herein, is generally intended to mean late-stage user(s) as opposed to early-stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of. or interaction, with some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof.

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

Terminology. The following paragraphs provide definitions and/or context for terms found in this disclosure (including the appended claims): “Comprising” And “contain” and variations of them-Such terms are open-ended and mean “including but not limited to”. When employed in the appended claims, this term does not foreclose additional structure or steps. Consider a claim that recites: “A memory controller comprising a system cache . . . ” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C . . . sctn. 112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

All terms of exemplary language (e.g., including, without limitation, “such as”, “like”, “for example”, “for instance”, “similar to”, etc.) are not exclusive of any other, potentially, unrelated, types of examples; thus, implicitly mean “by way of example, and not limitation . . . ”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” and “consisting of” limits the scope of a claim to the specified elements or method steps, plus those that do not materially affect the basis and novel characteristic(s) of the claimed subject matter (see Norian Corp. v Stryker Corp., 363 F.3d 1321, 1331-32, 70 USPQ2d 1508, Fed. Cir. 2004). Moreover, for any claim of the present invention which claims an embodiment “consisting essentially of” or “consisting of” a certain set of elements of any herein described embodiment it shall be understood as obvious by those skilled in the art that the present invention also covers all possible varying scope variants of any described embodiment(s) that are each exclusively (i.e., “consisting essentially of”) functional subsets or functional combination thereof such that each of these plurality of exclusive varying scope variants each consists essentially of any functional subset(s) and/or functional combination(s) of any set of elements of any described embodiment(s) to the exclusion of any others not set forth therein. That is, it is contemplated that it will be obvious to those skilled how to create a multiplicity of alternate embodiments of the present invention that simply consisting essentially of a certain functional combination of elements of any described embodiment(s) to the exclusion of any others not set forth therein, and the invention thus covers all such exclusive embodiments as if they were each described herein.

With respect to the terms “comprising,” “consisting of,” and “consisting essentially of,” where one of these three terms is used herein, the disclosed and claimed subject matter may include the use of either of the other two terms. Thus, in some embodiments not otherwise explicitly recited, any instance of “comprising” may be replaced by “consisting of” or, alternatively, by “consisting essentially of”, and thus, for the purposes of claim support and construction for “consisting of” format claims, such replacements operate to create yet other alternative embodiments “consisting essentially of” only the elements recited in the original “comprising” embodiment to the exclusion of all other elements.

Moreover, any claim limitation phrased in functional limitation terms covered by 35 USC § 112(6) (post AIA 112(f)) which has a preamble invoking the closed terms “consisting of,” or “consisting essentially of,” should be understood to mean that the corresponding structure(s) disclosed herein define the exact metes and bounds of what the so claimed invention embodiment(s) consists of, or consisting essentially of, to the exclusion of any other elements which do not materially affect the intended purpose of the so claimed embodiment(s). Furthermore, any statement(s), identification(s), or reference(s) to a structure(s) and/or element(s) that corresponds to and/or supports a claim limitation(s) phrased in functional limitation terms covered by 35 USC § 112(6) (post AIA 112(f)) should be understood to be identified by way of example and not limitation, and as such, should not be interpreted to mean that such recited structure and/or element is/are the only structure(s) and/or element(s) disclosed in this patent application that corresponds to and/or supports such claim limitations phrased in functional limitation terms. This claims interpretation intention also applies to any such subsequent statements made by Applicant during prosecution.

Devices or system modules that are in at least general communication with each other need not be in continuous communication with each other, unless expressly specified otherwise. In addition, devices or system modules that are in at least general communication with each other may communicate directly or indirectly through one or more intermediaries. Moreover, it is understood that any system components described or named in any embodiment or claimed herein may be grouped or sub-grouped (and accordingly implicitly renamed) in any combination or sub-combination as those skilled in the art can imagine as suitable for the particular application, and still be within the scope and spirit of the claimed embodiments of the present invention. For an example of what this means, if the invention was a controller of a motor and a valve and the embodiments and claims articulated those components as being separately grouped and connected, applying the foregoing would mean that such an invention and claims would also implicitly cover the valve being grouped inside the motor and the controller being a remote controller with no direct physical connection to the motor or internalized valve, as such the claimed invention is contemplated to cover all ways of grouping and/or adding of intermediate components or systems that still substantially achieve the intended result of the invention.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other. It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

As will be described in some detail below with reference to the accompanying Figures, many embodiments of the present invention may provide a radiation detection system using a removable cartridge module. The system includes scintillation detectors connected to a data acquisition system through the removable cartridge module. The scintillation detectors generate optical signals based on a level of radiation and send the detected optical signals to the data acquisition module using one or more fiber optic cables. The fiber optic cable(s) are permanently attached to the removable cartridge module. The removable cartridge module converts the optical signals into electrical signals to enable processing by the data acquisition system. The permanent fixing of fiber optic cables to the removable cartridge module provides a more reliable radiation measurement system when compared to using a SMA (SubMiniature version A) connector to connect each fiber optic cable to the data acquisition system.

In one embodiment a multi stranded fiber optic cable is connected to the data acquisition system using the cartridge module, wherein all the optical connections are permanently fixed and yet are easily connected or disconnected from the data acquisition system.

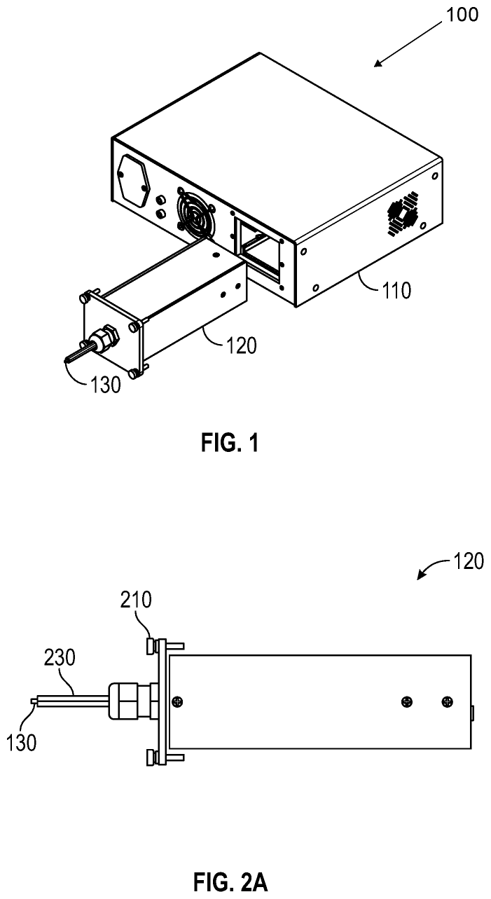

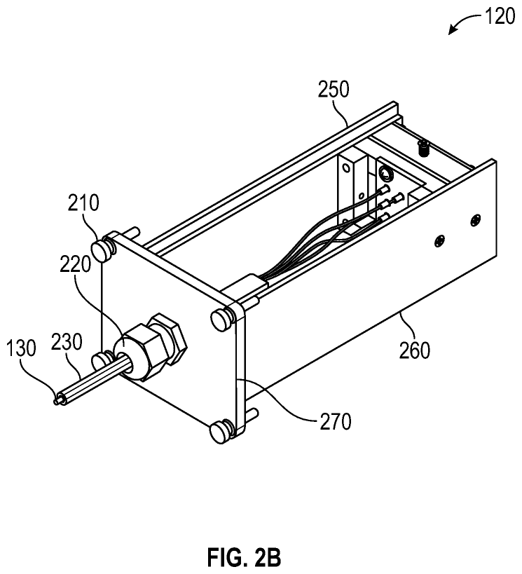

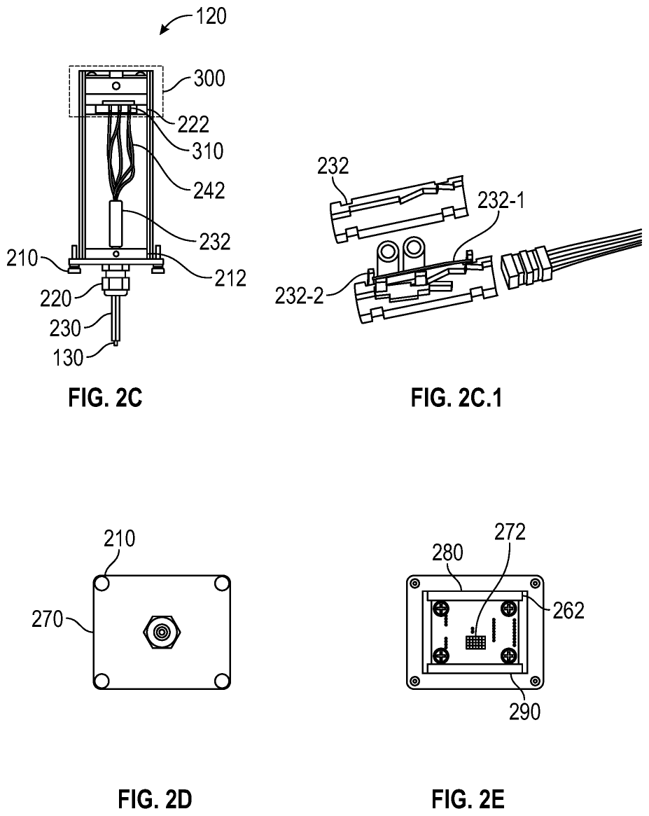

FIG. 1 is an illustration of an exemplary radiation measuring system comprising a removable cartridge module. In FIG. 1, different modules within a radiation measurement system 100 is shown. System 100 includes a data acquisition system or module 110, a removable cartridge module 120, and a multi stranded fiber optic cable or an optical fiber cable assembly 130. System 100, for example, without limitation, may be a Small Form-factor Pluggable (SFP) module with multi stranded fiber optic cable 130 permanently attached to the SFP module. Data acquisition system 110 includes for example, and without limitation, an electrometer for measuring the current generated by a radiation sensor. Removable cartridge module 120 may be viewed as comprising three distinctive subsystems: multi stranded fiber optic cable 130, a cartridge main assembly, and a removable connector assembly. Removable cartridge module 120 is described in more detail below with reference to FIGS. 2A-2E. Multi stranded fiber optic cable 130 may be a comercially available multi stranded plastic fiber optic cable, where in many practical embodiments, each strand may have a diameter approximately in the range of 0.25 mm to 2 mm. In some embodiments, multi stranded fiber optic cable 130 may be a multi-mode glass fiber optic cable. Optical fiber cable 130 can have 2, 4, 9, 16, 32, 64 or 128 strands in a single jacket. Further, fiber optic cable 130 is protected from physical damage with a plastic tubing or with an extra layer of a rubber jacket in addition to its original jacket.

In the present embodiment, in order to measure radiation, for example, without limitation, radiation from Linear Accelerator (LINACS), radiating material, for example, without limitation, Cobalt, or X-rays, at one end of optical fiber cable 130, each fiber strand or fiber pair is terminated in a scintillation detector with a configuration depending on the type of measurements an end user wants to make. The scintillation detectors may be cylindrical or spherical shaped structure and are glued or fused to each fiber optics strand. Further, the scintillation detectors are encapsulated in a plastic enclosure having a shape and arrangemenet based on end user requirements. Optical fiber cable 130 is typically long for example, without limitation, 4-20 meters to be able to reach the radiated areas. At the other end of optical fiber cable 130 each fiber optic strand or fiber pair is coupled to an optical transducer located inside a removable connector assembly 300 (shown in FIG. 2C) present inside cartridge module 120. Fiber optic cable 130 is permanently fixed to removable cartridge module 120 and carries the light signal from radiation sensors. The optical transducer, for example, without limitation, photodiodes, phototransistors, photodarlingtons, photoresistors, photovoltaic light sensors, complimentary metal oxide semiconductor transistor (CMOS) based charged couple devices (CCDs) or silicon based photomultipliers converts light to electrical signal. The converted electrical signal is sent to data acquisition system 110 to measure the radiation. Cartidge module 120 is electrically coupled to data acquisition system 110. The electrical connection between removable cartridge module 120 and data acquisition system 110 provides the more stable measurements when compared to connecting and disconnecting optic fibre cable 130 using optical connectors. Connecting or disconnecting fiber cable 130 may introduce dust in the optical connectors which may alter the results of the measurement if not properly accounted for. On the other hand, electricial connections are more robust to regular amount of dust and are very reliable. FIGS. 2A-2E illustrates different perspective views of cartridge module 120, in accordance with an embodiment of the present invention. Referring to FIGS. 2A-2E, removable cartridge module 120 comprises five dark, non-reflecting panels made of hard plastic material, for example, without limitation, acetal, Acrylonitrile Butadiene Styrene (ABS), poly carbonates (PC), etc. In some embodiments, the non-reflecting panels may be made of metal. The five panels include a left side panel 250, a right-side panel 260, a top panel 280, a bottom panel 290 and a faceplate 270. Left side panel 250, right-side panel 260, top panel 280, and bottom panel 290 provide a structure for cartridge module 120 and faceplate 270 makes the connection to data acquisition unit 110 of FIG. 1. The joins or contact areas between the panels are right angled connecting surfaces 262. Connecting surface 262 prevents light leakage into removable cartridge module 120 through the contact surfaces. The light leakage may be from the outer side of removable cartridge module 120. Further, two fram supports 212, 222 are used to facilitate assembling panels 250, 260, 280, 290 and to keep mating tolerances between the specified ranges. For example, without limitation, the mating tolerance is kept around +/−0.5 mm to have a better finishing. All panels 250, 260, 280, 290 are initially bolted to the frame supports 212, 222 but then they are glued to make for a stronger bond between the panels 250, 260, 280, 290 and face plate 270.

Cartridge module 120 provides multiple functions to system 100, of FIG. 1 such as, without limitation, holding removable connector assembly 300, providing strain and torsion relief to optic fiber cable 130, providing a very low light environment to prevent any ambient light leaking into removable connector assembly 300 or fiber strands that could make the readings invalid, providing a frame to hold removable connector assembly 300 to be able to engage with a backplate (not shown) of data acquisition unit 110 of FIG. 1, holding the cartridge to data acquisition unit 110 of FIG. 1.

FIG. 2A is a side perspective view of removable cartridge module 120, in accordance with an embodiment of the present invention. In FIG. 2A, thumb screws 210, a compression gland 220 to hold optical fiber cable 130, and a protective tubing 230 covering optical fiber cable 130 are shown. Thumb screws 210 or any other type of locking pins may be provided on corners of cartridge module 120 to engage cartridge module 120 with data acquisition system 110 of FIG. 1. Cartridge module 120 may be connected to or removed from data acquisition system 110 of FIG. 1, by screwing or unscrewing, respectively, of thumb screws 210 or by unlocking the locking pins. Compression gland 220 provides strain and torsion relief to optical fiber cable 130. Compression gland 220 is selected based on the diameter of the protective tubing and the thickness of faceplate 270. In the present embodiment, for example, without limitation, commercially available Essentra CGLN-NPT-3/8″-BK compression gland is used.

FIG. 2B is an isometric view (with top panel removed) of removable cartridge module 120, in accordance with an embodiment of the present invention. In FIG. 2B, left panel 250 and right panel 260 are shown.

FIG. 2C is a top perspective view of removable cartridge module 120, in accordance with an embodiment of the present invention. In FIG. 2C, frame supports 212, 222, a fan-out kit 232, fiber strand 242, removable connector assembly 300, and ferrules 310 are shown. Fan-out kit 232 is a commercially available kit, for example, without limitation, Corning FAN-BT25-12, operation of which is well known in the art and incorporated herein by reference. Fan-out kit 232 is used to protect each fiber strand typically with 0.25 mm diameter with a 900-um buffer, color coded tubing and to improve the adhesion of ferrule 310 to fiber optic strand 242. In the present embodiment, the standard Corning FAN-BT25-12 is implemented with a slight modification to the commercially available kit. One or more of plastic rings in the commercially available kit are cut off to make it fit inside cartridge module 120. In the present embodiment, plastics rings are completely cut off for fitting the fan-out kit 232 to fit inside the cartridge module and is illustrated in FIG. 2C.1. FIG. 2C.1 shows a cutoff point 232-1 at which plastic rings 232-2 are cut off.

FIG. 2D is a front view of removable cartridge module 120, in accordance with an embodiment of the present invention. In FIG. 2D, thumb screws 210 and face plate 270 are shown.

FIG. 2E is a rear view of removable cartridge module 120, in accordance with an embodiment of the present invention. In FIG. 2E, a multi-pin electrical connector 272 for engaging removable cartridge module 120 with data acquisition system 110 of radiation measuring system 100 of FIG. 1, is shown. Multi-pin electrical connector 272 mates with an electrical connector (not shown) in a back plate (not shown) of data acquisition system 110, of FIG. 1. Multi-pin electrical connector 272 may include a 1.4 mm to 2 mm pitch PCB socket type straight connector on cartridge module 120 side and a 2 mm shrouded quad row angled terminal strip type connector on data acquisition system 110 side. For example, without limitation, in the present embodiment a 24-pin commercially available Samtec SQT-106-01-F-Q connector is used. In the present embodiment, the optical signals from scintillation detectors are connected to removable cartridge module 120 through optical fiber cable 130 of FIG. 1, wherein the optical fiber cable 130 is permanently attached to the removable cartridge module 120. Cartridge module 120 is disconnected from radiation measuring system 100 of FIG. 1 from the point of multi-pin electrical connector 272. The electrical engagement point provides a more robust connection that is less suspectable to dust and variations in connector mating alignment, thereby overcome loss arising out of using removable optical connectors.

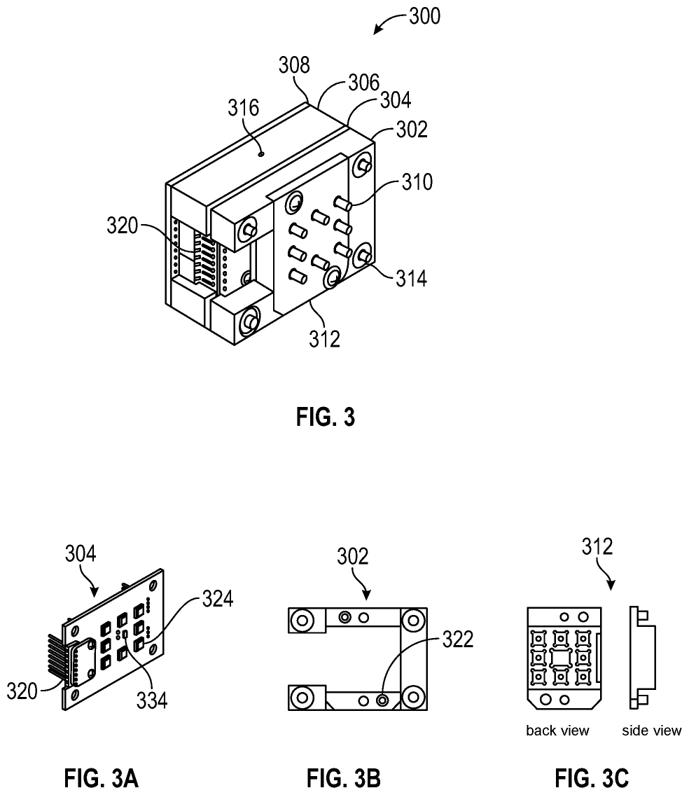

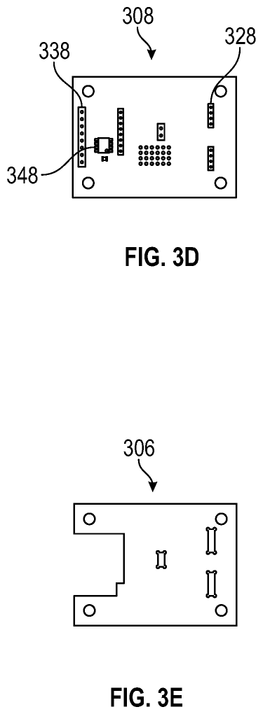

FIG. 3 is an illustration of a removable connector assembly 300 engaged with cartridge module 120, in accordance with an embodiment of the present invention. FIG. 3 illustrates removable connector assembly 300 in an assembled state. Removable connector assembly 300 is placed within cartridge module 120 and comprises mutliple parts, such as, without limitation, a top mount 302, a top board 304, a spacer 306, a bottom board 308, a ferrule holder 312 holding a pluraltiy of ferrules 310, a temperatue sensor breakout board 320, wherein each part is configured to perform a specific function for radiation measuring system 100 of FIG. 1. Further, removable connector assembly 300 includes a first set of screws 314 for connecting the multiple parts and a second set of screws 316 to engage with the cartridge module 120 of FIG. 1. In the present embodiment, exemplary removable connector 300 is attached to the cartridge module 120 with three flat head self tapping screws 316. In some embodiments, locking pins may be used to engage connector assmebly 300 with cartridge module 120. The multiple parts of removable connector assembly 300 are described below in detail with reference to FIGS. 3A-3E. The functions that may be performed by vairous parts of removable connector assembly 300 include, without limitation:
housing one or more optical transducers. The optical transducers or light transducers convert the light or optical signals from the optical fiber strands to an electrical signal that can be interpreted by data acquisition system 110 of FIG. 1,
providing mechancial and electrical connection for temperature sensors of radiation measuring system 100 of FIG. 1,
providing mechancial and electrical connection for memory Integrated Circuit (IC) for measuring system 100 of FIG. 1,
holding ferrules 310 at a specific distance based on the diameter and numercial aperture (NA) of optical fiber strands and anactive area of the light transducer used, such that the light coming out from the end of the optical fiber strands 242 illuminates the active area of the transducer. In the present embodiment, for example, without limitation, ferrules 310 are placed at a distance of 1.30 mm with a tolerance of ±0.7 mm for optical fiber strands with a diameter of 0.265 mm and NA of 0.5 and a transducer with an active area of 9 mm².,
holding multi-pin electrical connector 272 for engaging with the backplate connector of data acquisition system 110 of FIG. 1.

FIGS. 3A-3E illustrates various parts of removable connector assembly 300. FIG. 3A is an illustration of a top board 304 of removable connector assembly 300, in accordance with an embodiment of the present invention. Top board 304 is a printed circuit board (PCB) housing one or more light transducers 324 and includes one or more headers to carry electrical signals to bottom board 308 of FIG. 3. Top board 304 further includes mechanical and electrical connections to accommodate one or more temperature sensors 334. The temperature sensors 334 monitor the temperature of the transducer 324 to make any required temperature compensations in data acquisition system 110 of FIG. 1. FIG. 3A illustrates eight transducers 324 for simplicity. However, top board 304 may include as many number of transducers 324 as required by measuring system 100 of FIG. 1. A temperature sensor break out board 320 is housed in top board 304. In the present embodiment, top board 304 includes mechanical and electrical connection for one temperature sensor and mechanical connections for another temperature sensor. Further, in the present embodiment, commercially available temperature sensor, for example, without limitation, Adafruit 1782 is employed.

FIG. 3B is an illustration of a top mount 302 of removable connector assembly 300, in accordance with an embodiment of the present invention. Top mount 302 serves as a socket for connecting a ferrule holder 312 of FIG. 3 to removable connector 300 and also holds four nuts for the first set of screws 314 of FIG. 3, wherein the first set of screws 314 are used to connect multiple parts of removable connector assembly 300. Further, top mount 302 includes tapered heat-set inserts 322 to connect the screws from ferrule holder 312 of FIG. 3. In the present embodiment, top mount 302 is made of dark, non-reflecting plastic sheet like structure In some embodiments top mount 302 may be made of black and non-translucent material. In some other embodiments, top mount 302 may be made of a metal.

FIG. 3C is an illustration of a back view and a side view of a ferrule holder 312 of removable connector assembly 300, in accordance with an embodiment of the present invention. Ferrule holder 312 is a dark, non-reflecting plastic sheet for holding ferrules 310 and align them with the transducers 324 of top board 304 as shown in FIG. 3A. The alignment enables the light coming out of each fiber strand 242 of FIG. 2C to completely illuminate the active area of each transducer. Ferrule holder 312 is attached to top mount 302 of FIG. 3.

Ferrules 310 are stainless steel, ceramic or plastic structure enabling connections between fiber strands 242 and transducers 324. Stainless steel ferrule 310 allows fiber strands 242 to be terminated and polished with standard and inexpensive fiber optics techniques, and replace/repair individual fiber strands as opposed to having to discard the complete connector assembly because one fiber went bad. In the present embodiment, commercially available stainless-steel ferrules, for example, without limitations, Thorlabs Ferrule with Reference no. SF270-10 is used.

In some embodiments, ferrules 310 may be replaced using a metal part having holes for all the fibers strands 242 of FIG. 2C and glue all the fiber strands to this single metal part. This provides an advantage of including many more fibers in a smaller footprint.

FIG. 3D is an illustration of a bottom board 308 of removable connector assembly 300, in accordance with an embodiment of the present invention. Bottom board 308 is a printed circuit board (PCB) having multi-pin electrical connector 272 that mates with data acquisition system 110 of FIG. 1. Bottom board 308 also houses a memory IC. The memory chip stores the complete information related to the radiation sensors, for example, without limitation, a type, size, and an arrangement of sensors used, fiber length, date of manufacturing of cartridge module 120, model number, etc. Therefore, when cartridge module 120 of FIG. 1 is connected to data acquisition system 110, the sensor data is automatically passed to the data acquisition system 110 and may not require the user to type in all this information.

FIG. 3E is an illustration of a spacer 306 of removable connector assembly 300, in accordance with an embodiment of the present invention. Spacer 306 includes a dark, non-reflecting plastic sheet like structure for creating some separation between top board 304 and bottom board 308 of FIG. 3 to enable the headers and sockets between the two boards to mate properly.

All the features disclosed in this specification, including any accompanying abstract and drawings, may be replaced by alternative features serving the same, equivalent, or similar purpose, unless expressly stated otherwise. Thus, unless expressly stated otherwise, each feature disclosed is one example only of a generic series of equivalent or similar features.

It is noted that according to USA law 35 USC § 112 (1), all claims must be supported by sufficient disclosure in the present patent specification, and any material known to those skilled in the art need not be explicitly disclosed. However, 35 USC § 112 (6) requires that structures corresponding to functional limitations interpreted under 35 USC § 112 (6) must be explicitly disclosed in the patent specification. Moreover, the USPTO's Examination policy of initially treating and searching prior art under the broadest interpretation of a “mean for” or “steps for” claim limitation implies that the broadest initial search on 35 USC § 112(6) (post AIA 112(f)) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC § 112(6) (post AIA 112(f)) when such corresponding structures are not explicitly disclosed in the foregoing patent specification. Therefore, for any invention element(s)/structure(s) corresponding to functional claim limitation(s), in the below claims interpreted under 35 USC § 112(6) (post AIA 112(f)), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC § 112(6) (post AIA 112(f)) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC § 112(6) (post AIA 112(f)), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC § 112 (6). Applicant(s) note that all the identified documents above which are incorporated by reference to satisfy 35 USC § 112 (6) necessarily have a filing and/or publication date prior to that of the instant application, and thus are valid prior documents to incorporated by reference in the instant application.

Having fully described at least one embodiment of the present invention, other equivalent or alternative methods of implementing a removable cartridge system for radiation measurement according to the present invention will be apparent to those skilled in the art. Various aspects of the invention have been described above by way of illustration, and the specific embodiments disclosed are not intended to limit the invention to the particular forms disclosed. The particular implementation of the removable cartridge system for radiation measurement may vary depending upon the particular context or application. By way of example, and not limitation, removable cartridge system for radiation measurement described in the foregoing were principally directed to measuring radiation from LINACS, radiating materials or X-ray for imaging a field of view of the human body or radiotherapy implementations; however, similar techniques may instead be applied to any type of radiation measurement system such as, without limitation, nuclear medicine or measuring radiation in a nuclear reactor, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. That is, the Abstract is provided merely to introduce certain concepts and not to identify any key or essential features of the claimed subject matter. It is submitted with the understanding that it will not be used to limit or interpret the scope or meaning of the claims.

The following claims are hereby incorporated into the detailed description, with each claim standing on its own as a separate embodiment.

Only those claims which employ the words “means for” or “steps for” are to be interpreted under 35 USC 112, sixth paragraph (pre-AIA) or 35 USC 112(f) post-AIA. Otherwise, no limitations from the specification are to be read into any claims, unless those limitations are expressly included in the claims.

What is claimed is:

1. A system comprising:
an optical fiber cable assembly, said optical fiber cable assembly being configured to couple to one or more scintillation detectors;
a data acquisition module, said data acquisition module being configured to measure output generated by said one or more scintillation detectors; and
a cartridge module, said cartridge module being configured to engage with said optical fiber cable assembly and removably engage with said data acquisition module.

2. The system of claim 1, wherein said cartridge module further comprises a removable connector assembly.

3. The system of claim 1, wherein said cartridge module further comprises an electrical connector for removably engaging with said data acquisition module.

4. The system of claim 1, wherein said cartridge module further comprises a set of optical transducers for converting a first signal from said optical fiber cable assembly to a second signal form compatible with said data acquisition module.

5. The system of claim 4, wherein said cartridge module further comprises one or more temperature sensors for monitoring temperature of said set of optical transducers.

6. The system of claim 1, wherein said cartridge module further comprises a memory storing at least one of a type, size, and an arrangement of said scintillation detectors, length of said optic fiber assembly, date of manufacturing of said cartridge module, or a model number of said cartridge module.

7. The system of claim 1, wherein said optical fiber assembly comprises one or more fiber optic strands, wherein a first end of said one or more fiber optic strands are terminated in said one or more scintillation detectors based on a predefined configuration.

8. The system of claim 7, wherein said one or more scintillation detectors are cylindrical or spherical shaped and are glued or fused to said one or more fiber optic strands, respectively.

9. The system of claim 7, wherein said predefined configuration is based on a type of radiation measurement to be performed.

10. The system of claim 7, wherein a second end of said one or more fiber optic strands are coupled to said set of optical transducers.

11. The system of claim 10, wherein said second end of said one or more fiber optic strands are coupled to said set of optical transducers using ferrules.

12. The system of claim 1, wherein said data acquisition module comprises an electrometer measuring a current generated from the radiation detected by said one or more scintillation detectors.

13. A system comprising:
means for detecting radiation from one or more radiation sensors;
means for measuring radiation detected by said one or more radiation sensors: and
means for removably connecting said radiation detecting means to said radiation measuring means.

14. The system of claim 13, wherein said radiation detecting means is permanently fixed to said removably connecting means.

15. The system of claim 13, further comprises means for electrically engaging said removably connecting means with said radiation measuring means.

16. The system of claim 13, further comprises means for converting a first signal from said radiation detecting means to a second signal compatible with said radiation measuring means.

17. A device comprising:
an input region for receiving one or more optical fiber strands from a radiation detection module;
a housing comprising:
one or more optical transducers, wherein said one or more optical transducers convert optical signals from said optical fiber strands to an electrical signal;
one or more holders enabling connection between said optical fiber strands and said one or more optical transducers;
mechanical and electrical connections for one or more temperature sensors; and
mechanical and electrical connection for a memory Integrated Circuit (IC); and
an output region comprising an electrical connector for engaging with a radiation measuring module.

18. The device of claim 17, wherein said radiation detection module includes an optical fiber cable assembly coupled with one or more scintillation detectors.

19. The device of claim 17, wherein said radiation measuring module includes a data acquisition module for measuring output generated by said radiation detection module.

20. The device of claim 17, wherein said one or more holders include at least one of ferrules or a metal part having holes.
